(19) United States
(12) Patent Application Publication
(10) Pub. No.: US 2002/0154075 A1
(43) Pub. Date: Oct. 24, 2002

(54) Plasma display unit and substrate used in the same

(75) Inventors: Shinobu Sato, Tokyo (JP); Hiroshi Shirasawa, Tokyo (JP); Teruo Okamura, Tokyo (JP); Toshiro Wakabayashi, Tokyo (JP); Masahiro Shimizu, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 10/123,278

(22) Filed: Apr. 17, 2002

(30) Foreign Application Priority Data
Apr. 18, 2001 (JP) 2001-119315

(51) Int. Cl. G09G 3/28

(52) U.S. Cl. 345/60

(57) ABSTRACT

There is provided a plasma display unit including (a) a plasma display panel, (b) a first substrate on which a first drive circuit is fabricated for driving a first electrode, (c) a second substrate on which a second drive circuit is fabricated for driving a second electrode which cooperates with the first electrode to discharge therebetween to display images on the plasma display panel, (d) a third substrate which connects the first and second substrates to each other therethrough, and (e) at least one electronic part comprised of an electrically conductive pattern and formed on the third substrate which electronic part is to be mounted on the first or second substrate.

### BACKGROUND OF THE INVENTION

1. Field of the Invention

The invention relates to a plasma display unit, and more particularly to a plasma display unit including a circuit for collecting electric charges generated on a plasma display panel.

2. Description of the Related Art

In these days, a plasma display panel is widely used in fields of an outdoor big-size display unit, color television set, and so on, because a plasma display unit has the following advantages in comparison with other display units.

First, a plasma display unit can be fabricated thinner.

Second, a plasma display unit can have a greater display contrast ratio.

Third, a plasma display unit is more readily designed to include a big-size screen.

Fourth, a plasma display unit has a higher response speed.

Fifth, a plasma display unit emits a light by itself, and hence, a plasma display unit may be designed to emit various colored lights through the use of phosphor.

FIGS. 1A and 1B illustrate a conventional plasma display unit. FIG. 1B is a rear view of a conventional plasma display unit, and FIG. 1A is a cross-section taken along the line A-A in FIG. 1B.

The illustrated conventional plasma display unit includes a panel 101 having a top surface 101a on which images are displayed by emitting lights therefrom, and a rear surface 101b on which circuits are mounted.

On the rear surface 101b of the panel 101 are mounted a common substrate 102, a scanning substrate 103, a relay substrate 104 connecting the common substrate 102 and the scanning substrate 103 to each other, first data driver substrates 105, second data driver substrates 106, scanning drivers 107, and a digital substrate 108.

The panel 101 is comprised of a front substrate (not illustrated), a rear substrate (not illustrated), and discharge gas filled in discharge cells arranged between the front and rear substrates. A plurality of scanning electrodes and a plurality of sustaining electrodes (common electrodes) are alternately formed on the front substrate in stripe with adjacent electrodes being equally spaced from each other. A plurality of data electrodes are formed on the rear substrate in stripe in a direction perpendicular to a direction in which the scanning and sustaining electrodes extend, with adjacent electrodes being equally spaced from each other. Display cells are arranged at intersections of the scanning and sustaining electrodes and the data electrodes in a plan view. In the display cells, discharge gas filled in the display cells is discharged to thereby display desired images.

The scanning electrodes are controlled in operation in accordance with signals transmitted from the scanning drivers 107. The scanning drivers 107 are controlled in operation by a scanning electrode sustaining circuit formed on the scanning substrate 103. The sustaining electrodes are controlled in operation by a common electrode sustaining circuit formed on the common substrate 102. The data electrodes are controlled in operation in accordance with signals transmitted from the first and second data driver substrates 105 and 106. The digital substrate 108 controls an operation of the plasma display unit in its entirety.

A first circuit for collecting electric charges on a scanning electrode together with the scanning electrode sustaining circuit are formed on the scanning substrate 103, and a second circuit for collecting electric charges on a common electrode together with the common electrode sustaining circuit are formed on the common substrate 102.

With emission of lights from the panel 101, electric charges are accumulated on the panel 101. Electric charges accumulated on the panel 101 are moved to the relay substrate 104 through the first and second circuits, and then, collected to a capacitor formed on the relay substrate 104.

Each of the first and second circuits is designed to include a coil as a discrete part for collecting electric charges. As a coil, there is generally used an air-core coil 109, as illustrated in FIG. 1B.

An amount of electric charges generated on the panel 101 is dependent on factors such as the number of pixels the panel 101 has. It is necessary to vary a capacitance of the air-core coil 109 in order to adjust electric charge collection in accordance with variance in electric charges. In order to vary a capacitance of the air-core coil 109, it would be necessary to vary factors such as the number of the air-core coils 109, the number of windings in each of the air-core coils 109, and/or an outer diameter of each of the air-core coils 109.

In the conventional plasma display unit illustrated in FIG. 1B, the air-core coils 109 are fixed on the common substrate 102 and the scanning substrate 103. Accordingly, in order to vary a capacitance of the air-core coils 109, it was necessary to change the common substrate 102 and the scanning substrate 103 into others. Thus, the air-core coils 109 were quite inefficiently changed to others in the conventional plasma display unit.

A coil including the air-core coil 109 generally generates heat during operation. If the air-core coil 109 generates much heat, other electronic parts arranged in the vicinity of the air-core coil 109 might be harmfully influenced. Hence, it is preferable that the air-core coil 109 is spaced away from other electronic parts.

In addition, since the air-core coil 109 has a relatively great diameter, the air-core coil 109 occupies a relatively large area on the common substrate 102 and the scanning substrate 103 in a part-mounting area in which electronic parts are to be mounted. Thus, the air-core coil 109 reduces the part-mounting area.

The above-mentioned problems that the common substrate 102 and the scanning substrate 103 have to be wholly exchanged into others for changing the air-core coil 109 into another one, and the air-core coil 109 reduces the part-mounting area are caused also in other electronic parts such as a capacitor, as well as the air-core coil 109.

Japanese Unexamined Patent Publication No. 7-202374 (A) has suggested a printed circuit board having opposite surfaces on which electrically conductive patterns are printed. The electrically conductive patterns are electrically connected to each other through a through-hole formed with the printed circuit board. The electrically conductive patterns define a spiral coil having a core defined by an insulating area of the printed circuit board.

Japanese Unexamined Patent Publication No. 8-152865 (A) has suggested a circuit for driving a plasma display panel, including a first circuit comprised of a coil and a plurality of switches, and four switches. The first circuit is electrically connected in parallel to a capacitor formed between a scanning electrode and a sustaining electrode in a plasma display panel, and recharges the scanning and sustaining electrodes in opposite pole by virtue of resonant current generated when the capacitor is discharged between the scanning and sustaining electrodes. The four switches are electrically connected across opposite ends of the capacitor and a power source in order to clamp voltages at opposite ends of the capacitor into a power source voltage and the opposite pole of the power source voltage. The scanning and sustaining electrodes and the first circuit cooperate with each other to define a parallel resonant circuit.

Japanese Unexamined Patent Publication No. 10-11019 (A), which is based on United States patent application 06/911,396 filed on Sep. 25, 1986, has suggested a circuit for driving a panel, including a first circuit comprised of a capacitor, an inductor and a switch electrically connected in parallel to each other, the switch being turned off when a current running through the inductor becomes zero, a power source supplying a first voltage and a desired voltage, a panel electrode electrically connected to the first circuit, a first clamp unit electrically connected to the panel electrode, and clamping the panel electrode to the desired voltage in the power source, a second clamp unit electrically connected to the panel electrode, and clamping the panel electrode to the first voltage in the power source, a first driver which drives the first clamp unit when the first driver detects that a current runs through the inductor in an opposite direction, and a second driver which drives the second clamp unit when the second driver detects that a current runs through the inductor in an opposite direction.

Japanese Unexamined Patent Publication No. 11-306303 (A) has suggested a non-contact type IC card which transmits data or energy to and receives them from an external device in non-contact. The suggested IC card includes a coil or antenna comprised of a patterned electrical conductor formed on a substrate, an electronic circuit including at least two signal terminals one of which is electrically connected to the coil or antenna at an end, and electromagnetically transmitting data or energy to and receiving them from an external device through the coil or antenna, and a second electrical conductor formed on a surface of the substrate opposite to a surface on which the coil or antenna is formed, defining an electrostatic capacitor together with the coil or antenna through the substrate, and being electrically connected to the other of the signal terminals.

However, the above-mentioned Publications do not provide a motivation to solve the above-mentioned problems.

### SUMMARY OF THE INVENTION

In view of the above-mentioned problems in the conventional plasma display units, it is an object of the present invention to provide a plasma display unit which makes it no longer necessary to change common and scanning substrates to others for changing an electronic part, and which is capable of spacing an electronic part such as a coil from other parts, and avoiding reduction in a part-mounting area, caused by arrangement of an electronic part such as a three-dimensional coil.

It is also an object of the present invention to provide a relay substrate to be used for a plasma display unit which relay substrate can do the same as mentioned above.

In one aspect of the present invention, there is provided a plasma display unit including (a) a plasma display panel, (b) a first substrate on which a first drive circuit is fabricated for driving a first electrode, (c) a second substrate on which a second drive circuit is fabricated for driving a second electrode which cooperates with the first electrode to discharge therebetween to display images on the plasma display panel, (d) a first circuit formed on the first substrate for moving electric charges generated on the plasma display panel, (e) a second circuit formed on the second substrate for moving electric charges generated on the plasma display panel, (f) a third substrate which electrically connects the first and second circuits to each other therethrough and collects electric charges moved by the first and second circuits, and (g) at least one coil formed on the third substrate, the coil being comprised of an electrically conductive pattern.

In the plasma display unit in accordance with the present invention, there is used a coil formed on the third substrate, in place of an air-core coil used in a conventional plasma display unit. The coil is comprised of an electrically conductive pattern such as a metallic pattern.

A plurality of third substrates on which coils having capacitances different from one another are formed is prepared in advance. When it is necessary to change a capacitance of a coil, a third substrate on which a coil having a desired capacitance is formed is selected among a plurality of the third substrates, and is substituted for a currently used third substrate.

Thus, in the plasma display unit in accordance with the present invention, what is necessary to do when a capacitance of a coil is to be varied is to merely change a third substrate into another. That is, the plasma display unit in accordance with the present invention makes it no longer necessary to change a common substrate and a scanning substrate to others.

Thus, the plasma display unit in accordance with the present invention makes it possible to efficiently change a capacitance of a coil to a desired one.

In addition, a coil is formed on the third substrate which is spaced away from a common substrate and a scanning substrate in the plasma display unit in accordance with the present invention. Accordingly, even if a coil generates heat, electronic parts mounted on the common and scanning substrates are not harmfully influenced by such heat.

Furthermore, the plasma display unit in accordance with the present invention makes it no longer necessary to form a coil on common and scanning substrates unlike a conventional plasma display unit in which a coil was formed on both common and scanning substrates. Hence, a space occupied by a coil on common and scanning substrates is released, and accordingly, other electronic parts can be mounted in the space, ensuring an increase in an area of common and scanning substrates in which electronic parts are to be mounted.

The coil may be formed on opposite surfaces of the third substrate. As an alternative, the coil may be formed on one of opposite surfaces of the third substrate. By forming the coil only on one of opposite surfaces of the third substrate, it would be possible to simplify a process of fabricating the coil.

The coil may be in spiral form and be electrically connected to a connector formed on an opposite surface of the third substrate, through a contact hole formed with the third substrate.

There is further provided a plasma display unit including (a) a plasma display panel, (b) a first substrate on which a first drive circuit is fabricated for driving a first electrode, (c) a second substrate on which a second drive circuit is fabricated for driving a second electrode which cooperates with the first electrode to discharge therebetween to display images on the plasma display panel, (d) a third substrate which connects the first and second substrates to each other therethrough, and (e) at least one electronic part comprised of an electrically conductive pattern and formed on the third substrate which electronic part is to be mounted on the first or second substrate.

In accordance with the above-mentioned plasma display unit, electronic parts which were mounted on a common or scanning substrate as discrete parts in a conventional plasma display unit are formed on the third substrate as an electrically conductive pattern such as a metallic pattern.

Similarly to the above-mentioned coil, what is necessary to do when physical characteristics of electronic parts such as a capacitance or a resistance and/or specification of electronic parts are necessary to be varied is to merely change the third substrate to another third substrate on which a desired electronic part is mounted. Hence, it is no longer necessary to change common and scanning substrates to others.

Thus, it is possible to efficiently change physical characteristics of electronic parts such as a capacitance in a plasma display unit.

For instance, a capacitor or a coil may be selected as an electronic part.

In addition, an electronic part is formed on the third substrate which is spaced away from a common substrate and a scanning substrate in the plasma display unit in accordance with the present invention. Accordingly, even if an electronic part generates heat, electronic parts mounted on the common and scanning substrates are not harmfully influenced by such heat.

Furthermore, the plasma display unit in accordance with the present invention makes it no longer necessary to form an electronic part on common and scanning substrates unlike a conventional plasma display unit in which an electronic part such as a coil was formed on both common and scanning substrates. Hence, a space occupied by an electronic part on common and scanning substrates is released, and accordingly, other electronic parts can be mounted in the space, ensuring an increase in an area of common and scanning substrates in which electronic parts are to be mounted.

When a capacitor is selected as an electronic part, the capacitor may be defined by a first electrically conductive pattern formed on a first surface of the third substrate and a second electrically conductive pattern formed on a second surface of the third substrate such that the first and second electrically conductive patterns overlap each other.

In another aspect of the present invention, there is provided a substrate to be used in a plasma display unit including (a) a plasma display panel, (b) a first substrate on which a first drive circuit is fabricated for driving a first electrode, (c) a second substrate on which a second drive circuit is fabricated for driving a second electrode which cooperates with the first electrode to discharge therebetween to display images on the plasma display panel, (d) a first circuit formed on the first substrate for moving electric charges generated on the plasma display panel, and (e) a second circuit formed on the second substrate for moving electric charges generated on the plasma display panel, wherein the substrate electrically connects the first and second circuits to each other therethrough, and has at least one coil formed thereon, and the coil is comprised of an electrically conductive pattern and collects electric charges moving through the first and second circuits.

The above-mentioned third substrate in the plasma display unit in accordance with the present invention may be singly used, in which case, the same advantages as those obtained by the above-mentioned third substrate in the plasma display unit in accordance with the present invention are obtained.

It is preferable that the substrate includes coils formed on one of opposite surfaces thereof. As an alternative, the substrate may include a coil formed on opposite surfaces thereof.

There is further provided a substrate to be used for a plasma display unit including (a) a plasma display panel, (b) a first substrate on which a first drive circuit is fabricated for driving a first electrode, and (c) a second substrate on which a second drive circuit is fabricated for driving a second electrode which cooperates with the first electrode to discharge therebetween to display images on the plasma display panel, wherein the substrate connects the first and second substrates to each other therethrough, and having at least one electronic part formed thereon, and the electronic part which is to be mounted on the first or second substrate is comprised of an electrically conductive pattern.

The advantages obtained by the aforementioned present invention will be described hereinbelow.

In accordance with the plasma display unit and the substrate used for a plasma display unit, it is possible to form an electronic part such as a coil, which was mounted on a common substrate and/or a scanning substrate, on the substrate. Hence, physical characteristics of an electronic part such as a capacitance can be varied merely by changing the substrate into another one without necessity of changing common and scanning substrates to others.

In the plasmas display unit and the substrate both in accordance with the present invention, an electronic part such as a coil is formed on the substrate which is spaced away from a common substrate and a scanning substrate. Accordingly, even if an electronic part generates heat, such heat does not reach electronic parts mounted on the common and scanning.

Furthermore, the plasma display unit and the substrate both in accordance with the present invention makes it no longer necessary to form an electronic part such as a coil on common and scanning substrates unlike a conventional plasma display unit in which an electronic part such as a coil was formed on both common and scanning substrates. Hence, a space occupied by an electronic part on common and scanning substrates is released, and accordingly, other electronic parts can be mounted in the space, ensuring an increase in a density at which electronic parts are mounted on common and scanning substrates.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1A is a cross-sectional view taken along the line A-A in FIG. 1B.

FIG. 1B is a rear view of a conventional plasma display unit.

FIG. 2A is a top plan view of a relay substrate in accordance with the first embodiment of the present invention.

FIG. 2B is a rear view of the relay substrate illustrated in FIG. 2A.

FIG. 3A is a top plan view of a relay substrate in accordance with the second embodiment of the present invention.

FIG. 3B is a rear view of the relay substrate illustrated in FIG. 3A.

### DESCRIPTION OF THE PREFERRED EMBODIMENTS

Preferred embodiments in accordance with the present invention will be explained hereinbelow with reference to drawings.

[First Embodiment]

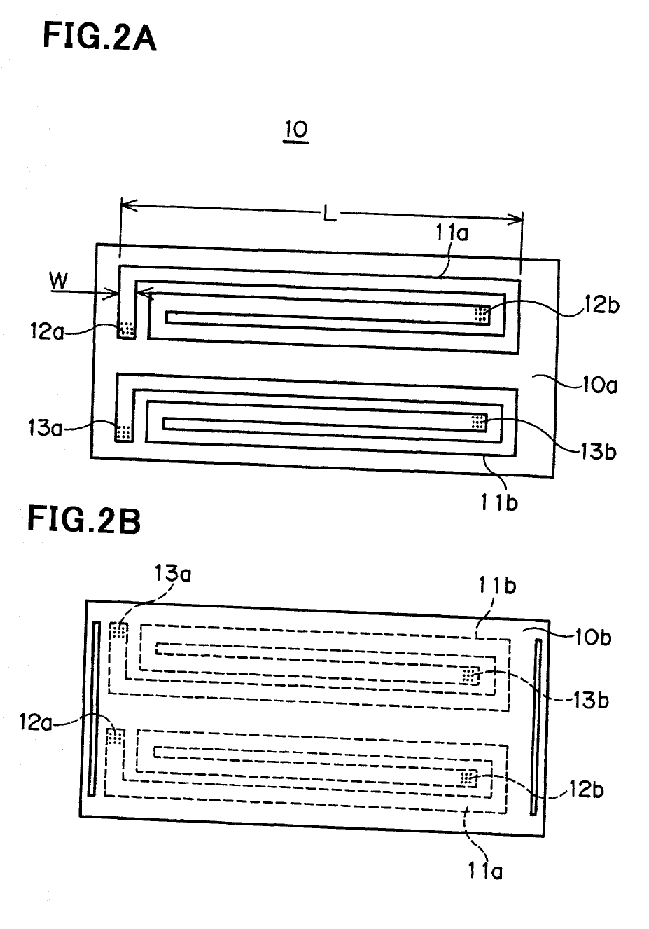

FIG. 2A is a top plan view of a relay substrate 10 in accordance with the first embodiment of the present invention, and FIG. 2B is a rear view of the relay substrate 10 illustrated in FIG. 2A.

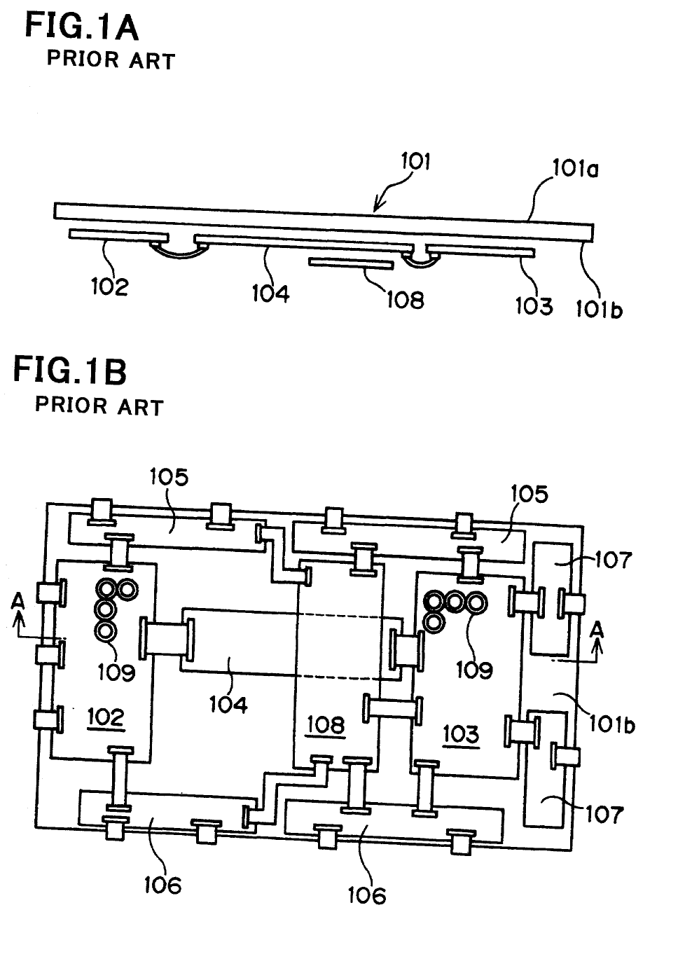

The relay substrate 10 in accordance with the first embodiment is used in place of the relay substrate 104 used in the conventional plasma display unit illustrated in FIGS. 1A and 1B.

The relay substrate 10 has a top surface 10a and a rear surface 10b. Two coils 11a and 11b each comprised of a copper pattern are formed on the top surface 10a. The copper pattern is in a spiral form having a bending angle of about 90 degrees. Opposite ends 12a and 12b of the coil 11a and opposite ends 13a and 13b of the coil 11b are electrically connected to the rear surface 10b through through-hole formed with the relay substrate 10. The coils 11a and 11b are electrically connected to the common substrate 102 and the scanning substrate 103 through connectors mounted on opposite edges of the rear surface 10b of the relay substrate 10.

Thus, the coils 11a and 11b are defined in a thickness-wise direction of the relay substrate 10.

When a capacitance of the coil 11a or 11b is to be changed, a length L and/or a width W of the coil 11a or 11b is changed. As an alternative, the number of windings or spirals of the coil 11a or 11b may be changed to change a capacitance of the coil 11a or 11b.

A plasma display unit including the relay unit 10 in accordance with the first embodiment collects electric charges in the same way as that of the conventional plasma display unit illustrated in FIGS. 1A and 1B.

A specification of a plasma display panel is dependent mainly on a panel size and the number of pixels. If a plasma display panel has sufficient capacitance in driving various driver ICs and a sufficient voltage is applied to a plasma display panel for driving various driver ICs, driver substrates can be used merely by varying a coil constant in the above-mentioned first and second circuits, if the number of pixels remains unchanged, even if a panel size is varied.

The relay substrate 10 in accordance with the first embodiment provides the following advantages.

When a capacitance of the coil 11a or 11b which is a part of a circuit for collecting electric charges is to be changed, a plurality of the relay substrates 10 on which the coils 11a and 11b having different capacitances from one another are formed are in advance prepared, a suitable one is selected among them, and the selected relay substrate is mounted in a plasma display unit. Thus, in order to change capacitances of the coils 11a and 11b, the relay substrate 10 is merely changed to another, ensuring that it is not necessary to change the common substrate 102 and the scanning substrate 103.

Accordingly, the relay substrate 10 in accordance with the first embodiment makes it possible to efficiently change a capacitance of a coil in a circuit for collecting electric charges.

In addition, the coils 11a and 11b are formed on the relay substrate 10 which is spaced away from the common and scanning substrate 102 and 103 in a plasma display unit including the relay substrate 10. Accordingly, even if the coils 11a and 11b generate heat, electronic parts mounted on the common and scanning substrates 102 and 103 are not harmfully influenced by such heat.

Furthermore, a plasma display unit including the relay substrate 10 makes it no longer necessary to form the coils 11a and 11b on the common and scanning substrates 102 and 103 unlike a conventional plasma display unit in which the air-core coil 109 was formed on both the common and scanning substrates 102 and 103. Hence, a space occupied by the air-coil 109 on the common and scanning substrates 102 and 103 is released, and accordingly, other electronic parts can be mounted in the space, ensuring an increase in a density at which electronic parts are mounted on the common and scanning substrates 102 and 103.

[Second Embodiment]

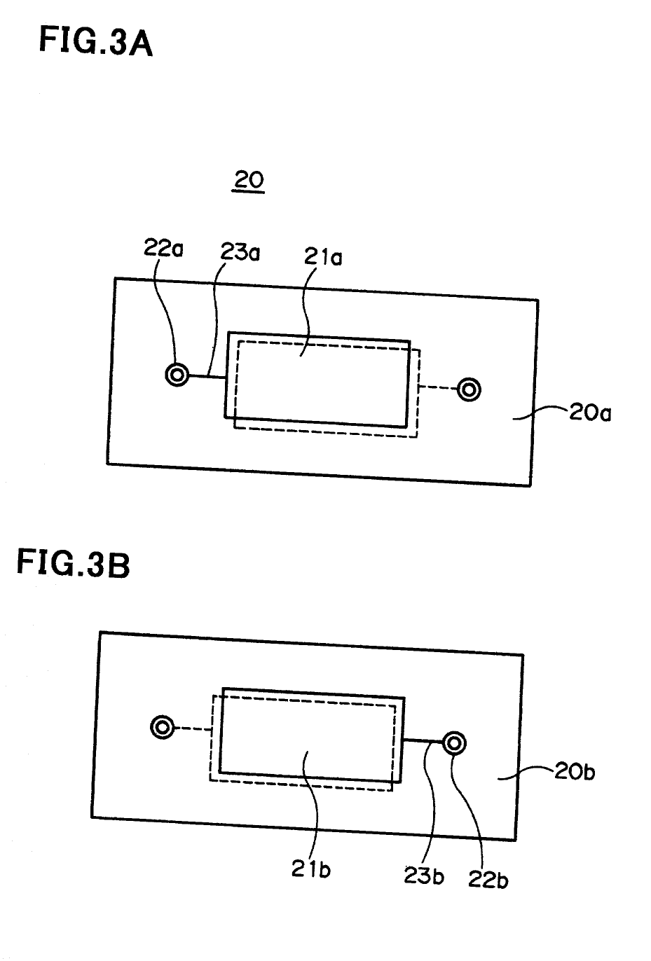

FIG. 3A is a top plan view of a relay substrate 20 in accordance with the second embodiment of the present invention, and FIG. 3B is a rear view of the relay substrate 20 illustrated in FIG. 3A.

The relay substrate 20 in accordance with the second embodiment is used in place of the relay substrate 104 used in the conventional plasma display unit illustrated in FIGS. 1A and 1B.

The relay substrate 20 is designed to have a capacitance for accumulating electric charges therein.

The relay substrate 20 has a top surface 20a and a rear surface 20b. On the top surface 20a are formed a rectangular copper pattern 21a, a terminal 22a, and a line 23a electrically connecting the copper pattern 21a and the terminal 22a to each other. On the rear surface 20b are formed a rectangular copper pattern 21b, a terminal 22b, and a line 23b electrically connecting the copper pattern 21b and the terminal 22b to each other. The copper patterns 21a and 21b overlaps each other, but slightly offsets each other. An area in which the rectangular copper patterns 21a and 21b overlap each other defines a capacity for accumulating electric charges therein. The capacity defined by the copper patterns 21a and 21b is electrically connected to the common and scanning substrates 102 and 103 through the terminals 22a and 22b.

When a capacitance of the capacity defined by the copper patterns 21a and 21b is to be changed, an area in which the copper patterns 21a and 21b overlap each other is increased or decreased.

A plasma display unit including the relay unit 20 in accordance with the second embodiment collects electric charges in the same way as that of the conventional plasma display unit illustrated in FIGS. 1A and 1B.

In accordance with the second embodiment, a capacity which was mounted on the common and scanning substrates 102 and 103 in the conventional plasma display unit is formed on the relay substrate 20. Hence, similarly to the relay substrate 10 in accordance with the first embodiment, a capacitance of the capacitor defined by the copper patterns 21a and 21b can be varied merely by changing the relay substrate 20 to another, ensuring that it is not necessary to change the common and scanning substrates 102 and 103.

Furthermore, a plasma display unit including the relay substrate 20 makes it no longer necessary to form a capacitor on the common and scanning substrates 102 and 103 unlike a conventional plasma display unit in which a capacitor was formed on both the common and scanning substrates 102 and 103. Hence, a space occupied by a capacitor on the common and scanning substrates 102 and 103 is released, and accordingly, other electronic parts can be mounted in the space, ensuring an increase in a density at which electronic parts are mounted on the common and scanning substrates 102 and 103.

Though the capacitor is formed on the relay substrate 20 as an example in the second embodiment, any other electronic parts may be formed on the relay substrate 20 in an electrically conductive pattern such as a metallic pattern.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-119315 filed on Apr. 18, 2001 including specification, claims, drawings and summary is incorporated herein by reference in its entirety.

What is claimed is:

1. A plasma display unit comprising:
(a) a plasma display panel;
(b) a first substrate on which a first drive circuit is fabricated for driving a first electrode;
(c) a second substrate on which a second drive circuit is fabricated for driving a second electrode which cooperates with said first electrode to discharge therebetween to display images on said plasma display panel;
(d) a first circuit formed on said first substrate for moving electric charges generated on said plasma display panel;
(e) a second circuit formed on said second substrate for moving electric charges generated on said plasma display panel;
(f) a third substrate which electrically connects said first and second circuits to each other therethrough and collects electric charges moved by said first and second circuits; and
(g) at least one coil formed on said third substrate, said coil being comprised of an electrically conductive pattern.

2. The plasma display unit as set forth in claim 1, wherein said coil is formed on one of opposite surfaces of said third substrate.

3. The plasma display unit as set forth in claim 1, wherein said coil is formed on opposite surfaces of said third substrate.

4. The plasma display unit as set forth in claim 1, wherein said coil is in spiral form and is electrically connected to a connector formed on an opposite surface of said third substrate, through a contact hole formed with said third substrate.

5. A plasma display unit comprising:
(a) a plasma display panel;
(b) a first substrate on which a first drive circuit is fabricated for driving a first electrode;
(c) a second substrate on which a second drive circuit is fabricated for driving a second electrode which cooperates with said first electrode to discharge therebetween to display images on said plasma display panel;
(d) a third substrate which connects said first and second substrates to each other therethrough; and
(e) at least one electronic part comprised of an electrically conductive pattern and formed on said third substrate which electronic part is to be mounted on said first or second substrate.

6. The plasma display unit as set forth in claim 5, wherein said electronic part is a coil.

7. The plasma display unit as set forth in claim 6, wherein said coil is formed on one of opposite surfaces of said third substrate.

8. The plasma display unit as set forth in claim 6, wherein said coil is formed on opposite surfaces of said third substrate.

9. The plasma display unit as set forth in claim 6, wherein said coil is in spiral form and is electrically connected to a connector formed on an opposite surface of said third substrate, through a contact hole formed with said third substrate.

10. The plasma display unit as set forth in claim 5, wherein said electronic part is a capacitor.

11. The plasma display unit as set forth in claim 10, wherein said capacitor is defined by a first electrically conductive pattern formed on a first surface of said third substrate and a second electrically conductive pattern formed on a second surface of said third substrate such that said first and second electrically conductive patterns overlap each other.

12. A substrate to be used in a plasma display unit comprising:
(a) a plasma display panel;
(b) a first substrate on which a first drive circuit is fabricated for driving a first electrode;
(c) a second substrate on which a second drive circuit is fabricated for driving a second electrode which cooperates with said first electrode to discharge therebetween to display images on said plasma display panel;
(d) a first circuit formed on said first substrate for moving electric charges generated on said plasma display panel; and
(e) a second circuit formed on said second substrate for moving electric charges generated on said plasma display panel,
wherein said substrate electrically connects said first and second circuits to each other therethrough, and has at least one coil formed thereon, and
said coil is comprised of an electrically conductive pattern and collects electric charges moving through said first and second circuits.

13. The substrate as set forth in claim 12, wherein said substrate includes coils formed on one of opposite surfaces thereof.

14. The substrate as set forth in claim 12, wherein said substrate includes a coil formed on opposite surfaces thereof.

15. The substrate as set forth in claim 12, wherein said coil is in spiral form and is electrically connected to a connector formed on an opposite surface of said substrate, through a contact hole formed with said substrate.

16. A substrate to be used for a plasma display unit comprising:
(a) a plasma display panel;
(b) a first substrate on which a first drive circuit is fabricated for driving a first electrode; and
(c) a second substrate on which a second drive circuit is fabricated for driving a second electrode which cooperates with said first electrode to discharge therebetween to display images on said plasma display panel,
wherein said substrate connects said first and second substrates to each other therethrough, and having at least one electronic part formed thereon, and
said electronic part which is to be mounted on said first or second substrate is comprised of an electrically conductive pattern.

17. The substrate as set forth in claim 16, wherein said electronic part is a coil.

18. The substrate as set forth in claim 17, wherein said coil is formed on one of opposite surfaces of said substrate.

19. The substrate as set forth in claim 17, wherein said coil formed on opposite surfaces of said substrate.

20. The substrate as set forth in claim 17, wherein said coil is in spiral form and is electrically connected to a connector formed on an opposite surface of said substrate, through a contact hole formed with said substrate.

21. The substrate as set forth in claim 16, wherein said electronic part is a capacitor.

22. The substrate as set forth in claim 21, wherein said capacitor is defined by a first electrically conductive pattern formed on a first surface of said substrate and a second electrically conductive pattern formed on a second surface of said substrate such that said first and second electrically conductive patterns overlap each other.
